(19) United States
(12) Patent Application Publication
(10) Pub. No.: US 2003/0159913 A1
(43) Pub. Date: Aug. 28, 2003

(54) Portable reactor

(76) Inventor: Philippe R. Murcia, White Plains, NY (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/082,475

(22) Filed: Feb. 22, 2002

(51) Int. Cl. C10B 47/00; B09B 3/00; C10B 1/08

(52) U.S. Cl. 201/35; 201/21; 202/128; 202/242; 202/245; 422/198; 422/202

(57) ABSTRACT

A portable reactor container that contains a removable fire grate enclosure and an incline on its floor that slopes to a discharge port. Heating elements are arranged between the enclosure and the container. A heat recovery section, which may be a water reservoir, surrounds the outside of the container to convert water into steam by absorbing heat leaving the container. The enclosure may be inserted into or removed from the container with a forklift. Wood waste or other wood waste material may be filled into the fire crate enclosure to be transformed into wood charcoal by heating appropriately while the container is hermetically sealed.

### BACKGROUND OF THE INVENTION

1. Field of the Invention

The present invention relates to a portable reactor for making charcoal from forestry wood waste and/or any waste that can be used for obtaining methanol, acids, or finished products and/or for providing sustainable and renewable energy.

2. Discussion of Related Art

Conventionally, charcoal is made by using either an earth pit or a brick kiln. Most of the cost in the manufacture of charcoal is that which is associated with the transportation of the raw wood to the central processing site. For example, cut trees are transported by truck or train to a centralized processing site, where the charcoal is manufactured.

Approximately one third of the volume of trees cut down is not transported to the central processing site, meaning that loggers must cut down fifty percent (50%) more trees than if the entire tree is used. Thus, more trees are cut down because the centrally located kilns do not utilize the leftover. Also, the planting of new trees is also inhibited because of the abundance of wood waste.

The leftover wood is typically discarded and left on the forest floor. While the leftover wood is still moist, new types of fungi and insect species appear on the leftover wood, which can ruin new tree generation and may adversely affect human health. In addition, once the leftover wood becomes dry it becomes extremely combustible. The presence of combustible matter throughout the forest is a significant reason for increased forest fires.

Such leftover wood turns the forest into a carbon dioxide (CO₂) supplier, instead of a natural “sink” that soaks up gases responsible for the “greenhouse” effect that causes global warming, and thereby jeopardizes the balance of the existing ecosystem. On the other hand, usable wood which is not of sufficient volume to be transported cost effectively is either disposed of or salvaged by expensive and time consuming techniques. However, it never gets used in a charcoal making process.

The traditional method of making charcoal in an earth pit requires several days, or even weeks, for the wood to be properly seasoned and dried prior to being heated. Furthermore, the charcoal and by-products, which are tar and ash, can not be fully recovered because they all seep into the earth. Another disadvantage is that the recovered charcoal is often contaminated with earth and stones. Making charcoal using this method can often take more than one week after the wood is dried.

The traditional method of making charcoal in centrally located brick kilns on the other hand has no problems with loss of charcoal, because in most brick kilns tar condensation is not collected. However, brick kilns require constant supervision.

The carbonization stage may be decisive in charcoal production even though it is not the most expensive one. Unless it is carried out as efficiently as possible, it puts the whole operation of charcoal production at risk since low yields in carbonization reflect back through the whole chain of production as increased costs and waste of resources.

Wood consists of three main components: cellulose, lignin and water.

The cellulose and lignin and some other materials are tightly bound together and make up the material we call wood. The water is absorbed or held as molecules of water on the cellulose/lignin structure. Air dry or “seasoned” wood still contains 12 to 18% of absorbed water. Growing, freshly cut or “unseasoned” wood contains, in addition, liquid water to give a total water content of about −40 to 100% expressed as a percentage of the oven dry weight of the wood.

The water in the wood has to be driven off as vapor before carbonization can take place. To evaporate water requires a lot of energy so that using the sun to pre-dry the wood as much as possible before carbonization greatly improves efficiency which in turn allows CO₂ to be released. The water remaining in the wood to be carbonized must be evaporated in the kiln or pit and this energy must be provided by burning some of the wood itself which otherwise would be converted into useful charcoal.

The first step in carbonization in the kiln is drying out of the wood at 100° C. or below to zero moisture content. The temperature of the oven dry wood is then raised to about 280° C. The energy for these steps comes from partial combustion of some of the wood charged to the kiln or pit and it is an energy absorbing or endothermic reaction.

When the wood is dry and heated to around 280° C., it begins to spontaneously break down to produce charcoal plus water vapor, methanol, acetic acid and more complex chemicals, chiefly in the form of tars and non-condensable gas consisting mainly of hydrogen, carbon monoxide and carbon dioxide. Air is admitted to the carbonizing kiln or pit to allow some wood to be burned and the nitrogen from this air will also be present in the gas. The oxygen of the air is sued up in burning part of the wood charged.

The spontaneous breakdown or carbonization of the wood above a temperature of 280° C. liberates energy and hence this reaction is said to be exothermic. This process of spontaneous breakdown or carbonization continues until only the carbonized residue called charcoal remains. Unless further external heat is provided, the process stops and the temperature reaches a maximum of about 400° C. This charcoal, however, will still contain appreciable amounts of tarry residue, together with the ash of the original wood. The ash content of the charcoal is about 3 to 5%; the tarry residue may amount to about 30% by weight and the balance is fixed carbon—about 65 to 70%. Further, heating increases the fixed carbon content by driving off and decomposing more of the tars. A temperature of 500° C. gives a typical fixed carbon content of about 85% and a volatile content of about 10%. The yield of charcoal at this temperature is about 33% of the weight of the oven dry wood carbonized—not counting the wood, which was burned to carbonize the remainder. Thus the theoretical yield of charcoal varies with temperature of carbonization due to the change in its content of volatile tarry material. The following table shows the effect of final carbonization temperature on the yield and composition of the charcoal.

Effect of carbonization temperature on yield and composition of charcoal:

| Carbo- | Chemical analysis of | |
|---|---|---|
| nization | charcoal oven dry | |
| Temperature | wood of fixed | Charcoal yield based on |

| ° C. | charcoal content % | volatile material | 0% moisture |
|---|---|---|---|
| 300 | 68 | 31 | 42 |
| 500 | 86 | 13 | 33 |
| 700 | 92 | 7 | 30 |

Low carbonization temperatures give a higher yield of charcoal but this charcoal is low grade, is corrosive due to its content of acidic tars, and does not burn with a clean smoke-free flame. Good commercial charcoal should have a fixed carbon content of about 75% and this calls for a final carbonizing temperature of around 500° C.

The yield of charcoal also shows some variation with the kind of wood. There is evidence that the lignin content of the wood has a positive effect on charcoal yield. A high lignin content gives a high yield of charcoal. Therefore, mature wood in sound condition is preferred for charcoal production. Dense wood also tends to give a dense, strong charcoal, which is also desirable. However, very dense woods sometimes produce a friable charcoal because the wood tends to shatter during carbonization. The friability of charcoal increases as carbonization temperature increases and the fixed carbon content increases as the volatile matter content falls. A temperature of 450 to 500° C. gives an optimum balance between friability and the desire for a high fixed carbon content.

The many variables possible in carbonization make it difficult to specify an optimum procedure—generally the best results will be obtained by using sound hardwood of medium to high density. The wood should be as dry as possible and usually be split to eliminate pieces more than 20 dm thick. Firewood, which will be burned up inside the kiln or pit to dry out and start carbonization of the remainder, can be of inferior quality and temperature. One should try and reach a final temperature of around 500° C. through the whole of the charge. With pits this is difficult since the air circulation and cooling effects are irregular and cold spots occur. These produce “brands” of uncarbonized wood. Trying to reach a final overall temperature of 500° C. with a pit or kiln having poor and irregular air circulation usually results in burning part of the charcoal to ashes, while leaving other parts of the charge only partly carbonized. Hence the importance of using well designed kilns properly operated for an efficient charcoal operation.

The wood should be felled, cut up and stacked at least three weeks before heating in a reactor, if the maximum yield of charcoal is to be obtained. Dry wood needs less charring time and increases the conversion efficiency of the process. When wet wood is used, the charring period is likely to be extended. Because of the increased amount of wood burned internally to drive off the excess moisture, lower yields of charcoal are to be expected.

Carbonization produces substances, which can prove harmful, and simple precautions should be taken to reduce risks.

The gas produced by carbonization has a high content of carbon monoxide, which is poisonous when breathed. Therefore, when working around the kiln or pit during operation and when the kiln is opened for unloading, care must be taken that proper ventilation is provided to allow the carbon monoxide, which is also produced during unloading through spontaneous ignition of the hot charcoal, to be dispersed.

The tars and smoke produced from carbonization, although not directly poisonous, may have long-term damaging effects on the respiratory system. Housing areas should, where possible, be located so that prevailing winds carry smoke from charcoal operations away from them and batteries of kilns should not be located in close proximity to housing areas.

Wood tars and pyroligneous acid can be irritant to skin and care should be taken to avoid prolonged skin contact by providing protective clothing and adopting working procedures that minimize exposure.

The tars and pyroligneous liquors can also seriously contaminate streams and affect drinking water supplies for humans and animals. Fish may also be adversely affected. Liquid effluents and waste water from medium and large scale charcoal operations should be trapped in large settling ponds and allowed to evaporate so that this water does not pass into the local drainage system and contaminate streams.

Fortunately kilns and pits, as distinct from retorts and other sophisticated systems, do not normally produce liquid effluent—the by-products are mostly dispersed into the air as vapors. Precautions against airborne contamination of the environment are of greater importance in this case.

Charcoal ready for use by the consumer implies a certain sequence of steps in a production chain all of which are important and all of which must be carried out in the correct order. They have varying incidence on production cost. Noting these differences enables the importance of each step or unit process to be assessed so that attention may be concentrated on the most costly links of the production chain.

Charcoal is the solid residue remaining when wood is “carbonized” or “pyrolysed” under controlled conditions in a closed space such as a charcoal kiln. Control is exercised over the entry of air during the pyrolysis or carbonization process so that the wood does not merely burn away to ashes, as in a conventional fire, but decomposes chemically to form charcoal.

Air is not really required in the pyrolysis process. In fact, advanced technology methods of charcoal production do not allow any air to be admitted resulting in a higher yield, since no extra wood is burned with the air and control of quality is facilitated.

The pyrolysis process once started, continues by itself and gives off considerable heat. However, this pyrolysis or thermal decomposition of the cellulose and lignin of which the wood is composed does not start until the wood is raised to a temperature of about 300° Celsius.

In the traditional charcoal kiln or pit some of the wood loaded into the kiln is burned to dry the wood and raise the temperature of the whole of the wood charge so that pyrolysis starts and continues to completion by itself. The wood burned in this way is lost. By contrast, the success of sophisticated continuous retorts in producing high yields of quality charcoal is due to the ingenious way in which they make use of the heat of pyrolysis, normally wasted to raise the temperature of the incoming wood so that pyrolysis is accomplished without burning additional wood. Although some heat impact is needed to make up for heat losses through the walls and other parts of the equipment. The combustible wood gas given off by the carbonizing wood can be burned to provide this heat and to dry the wood. All carbonizing systems give higher efficiency when fed with dry wood since removal of water from wood needs large inputs of heat energy.

The pyrolysis process produces charcoal, which consists mainly of carbon together with a small amount of tarry residues, ash, combustible gases, tars, a number of chemicals that are mainly acetic acid and methanol, and a large amount of water. The water is given off as vapor from the drying and pyrolitic decomposition of the wood.

When pyrolysis is completed, the charcoal that has arrived at a temperature of about 500° C. is allowed to cool down without access of air. It is then safe to unload and ready for use.

The overwhelming bulk of the world's charcoal is still produced by the simple process briefly described previously. It wastefully burns part of the wood charge to produce initial heat and does not recover any of the by-products or the heat given off by the pyrolysis process.

Other woody materials such as nutshells and bark are sometimes used to produce charcoal. Wood is, however, the preferred and most widely available material for charcoal production. Many agricultural residues can also produce charcoal by pyrolysis but such charcoal is produced as a fine powder, which usually must be briquetted at extra cost for most charcoal uses.

On the grounds of availability, properties of the finished charcoal, and sound ecological principles wood remains the preferred and most widely used raw material and there appears to be no reason why this should change in the future.

Charcoal making can be divided into several stages or unit operation. They are: growing the fuel wood, wood harvesting, drying and preparing the wood for carbonization, carbonizing the wood to charcoal, screening storage and transporting to warehouse or distribution points.

It would be desirable to provide a method and apparatus for making charcoal in a mobile, potable reactor unit that can use all wood waste cost effectively. It is a further object of this invention to provide a method and apparatus for making charcoal in a mobile, portable reactor unit with minimal need for supervision. It is a further object of this invention to provide a method and apparatus for making charcoal in a mobile, portable reactor unit in all environmental settings.

### SUMMARY OF THE INVENTION

One aspect of the invention resides in a mobile reactor for making charcoal from wood waste. The reactor is transported to a forested area that is being, or recently has been logged. The wood waste employed is any part of a cut tree that has not been transported, including portions of the tree trunk, large branches, small branches, bark and peat. The reactor can be placed on the ground or on a vehicle, such as a flat bed truck. Once the reactor is assembled and filled, the wood is consumed to make charcoal. During the carbonization process, the reactor can be transported. Once the carbonization process is completed, the reactor can be easily emptied of both the charcoal and byproducts.

Another aspect of the invention resides in a portable reactor that has a hermetically sealed container and a reactor that has a fire grate. Heating elements surround the fire grate and provide heat to the container. A water reservoir surrounds are arranged on the exterior of the heating elements that absorb heat given off from the heating elements that is not used to heat the container so as to transform water within the water reservoir into steam.

Wood or other products that may be transformed into wood charcoal are inserted into the container before it is hermetically sealed. The container is inserted into the reactor. A hermetically sealed discharge valve is located at the lowest elevation of the container. Inside the container, the bottom floor slopes to the discharge valve. During the transformation process, various substances in liquid form, such as tar, emerge that will flow down the sloping floor to the discharge valve.

A further sealed receptacle is attached to the reactor container via the discharge valve, which is open during the attachment to permit the flow of tar and other liquids to flow into the receptacle. Once the receptacle has received all the liquid tar and other substances that will be formed, it may be removed, which action triggers the discharge valve to hermetically seal to prevent the entry of any air into the reactor container.

### BRIEF DESCRIPTION OF THE DRAWINGS

For a better understanding of the present invention, reference is made to the following description and accompanying drawings, while the scope of the invention is set forth in the appended claims:

FIG. 1 is a schematic representation of an elevation view of a portable container reactor in accordance with the invention

FIG. 2 is a schematic representation of a front plan view of the portable container reactor of FIG. 1.

FIG. 3 is schematic representation of a right side view of the portable container reactor in accordance with FIG. 1.

FIG. 4 is a schematic representation of a top inside view of the portable container reactor in accordance with FIG. 1.

FIG. 5 is a perspective front view of the reactor showing the door in an open condition and a door sealing mechanism in a retracted condition.

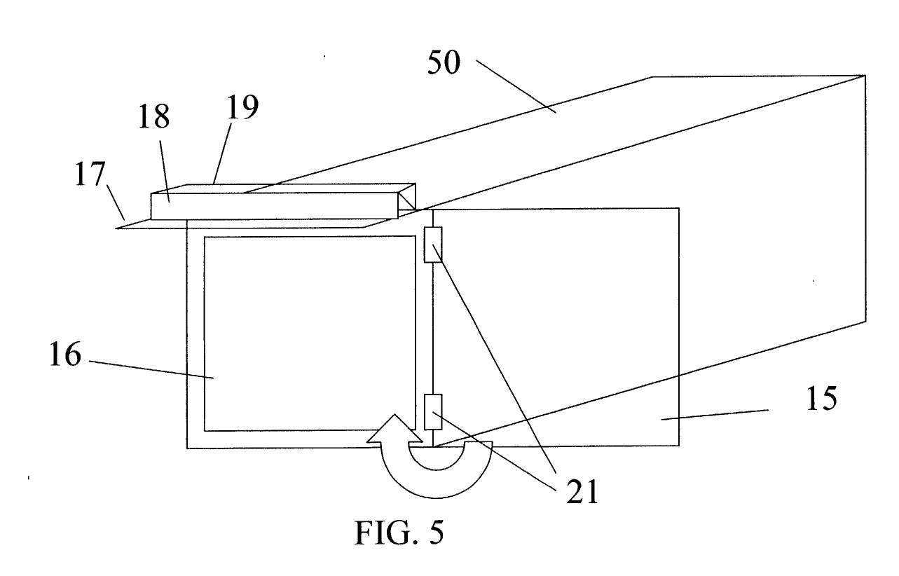

FIG. 6 is a left side elevation view of the reactor showing the door in a closed condition and the door sealing mechanism in an extended condition pressing against the door.

FIG. 7 is a rear view of the reactor showing the water reservoir arranged in a serpentine fashion.

### DESCRIPTION OF THE PREFERRED EMBODIMENT

A portable reactor unit arrives at a forest or other logging site for processing the wood waste that remains at the site. Wood waste includes anything from unused tree trunks to small branches, bark, peat and nuts. The portable reactor unit may be transported via a flat top truck or a flat bed trailer. To avoid the unnecessary carrying of wood, the reactors should frequently be brought to new sites adjacent to the wood supply.

For economy of labor, two or more reactors may be operated as a group within reasonable walking distance of each other. This enables operators to unload and load one unit when the other reactors are in the carbonization or cooling stage. Unlike the case for conventional kilns, there is no need to pre-dry the wood by the sun to improve efficiency, which means that CO₂ will not be released into the air from wood drying by the sun.

The weight of charcoal produced in each batch operation of a transportable metal reactor is related to several physical factors. The main factors that contribute toward maximum yields are high timber density and low moisture content of the wood.

Moisture Content. Charcoal fresh from an opened reactor contains very little moisture, usually less than 1%. Absorption of moisture from the humidity of the air itself is rapid and there is, with time, a gain of moisture, which even without any rain wetting can bring the moisture content to about 5 to 10%, even in well-burned charcoal. When the charcoal is not properly burned or where pyroligneous acids and soluble tars have been washed back onto the charcoal by rain, as can happen in pit and mound burning, the hygroscopitity of the charcoal can rise to 15% or even more. Moisture is an adulterant, which lowers the calorific or heating value of the charcoal.

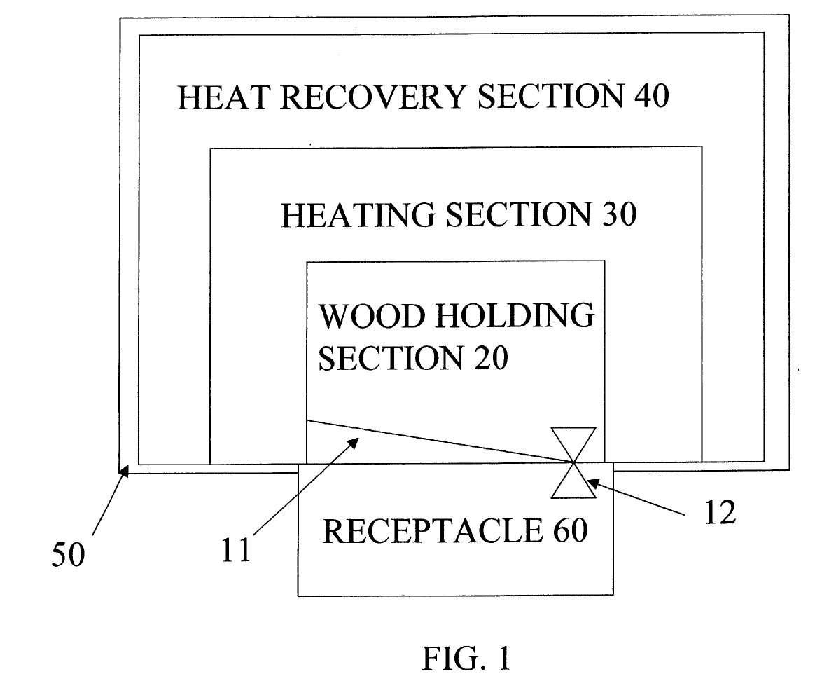

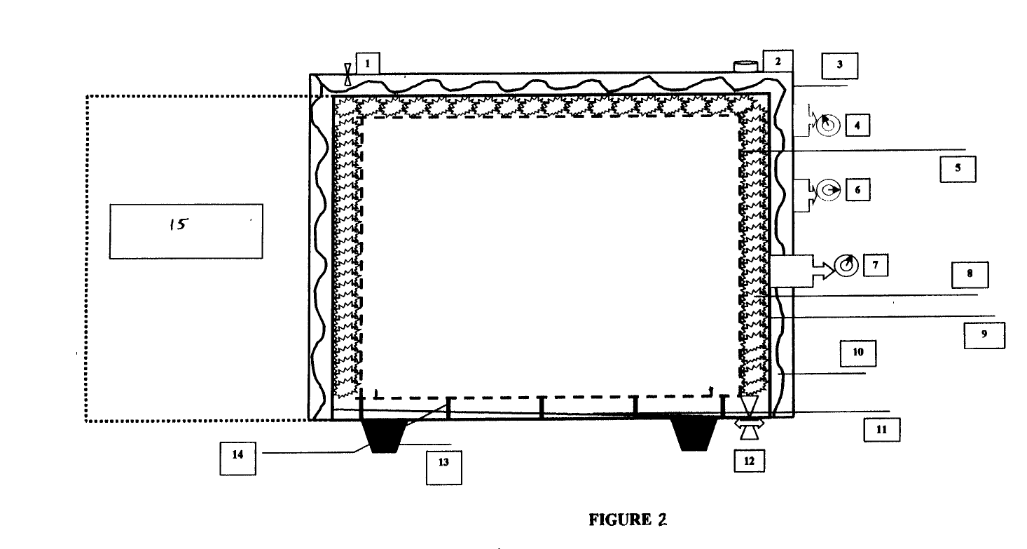

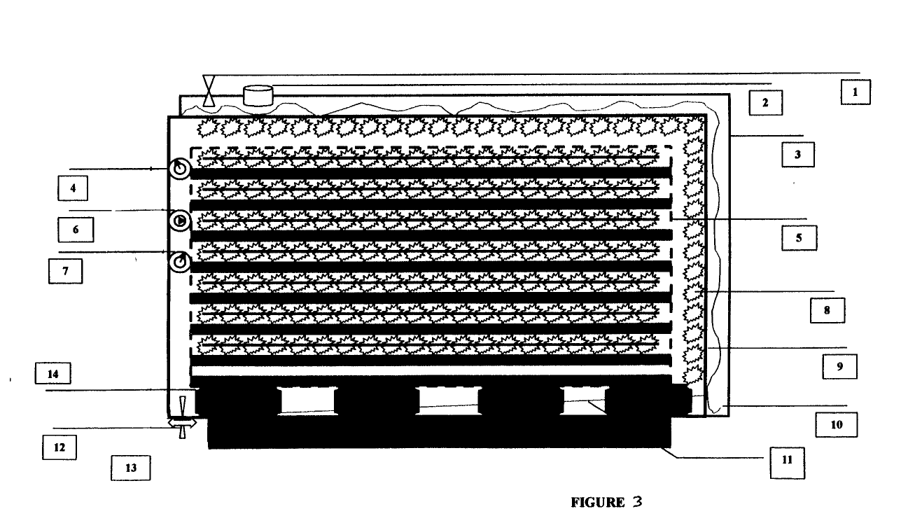

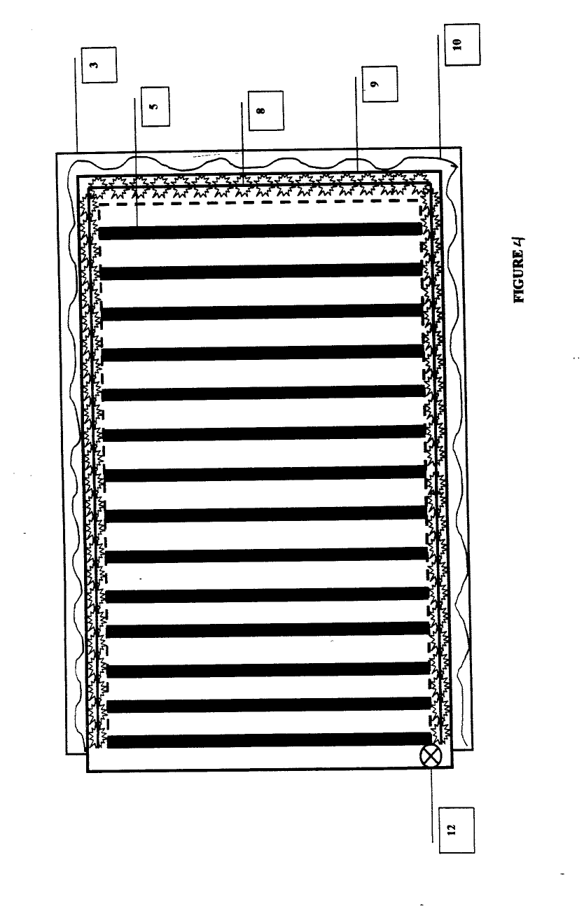

Turning to FIGS. 1-4, a portable reactor is depicted. The reactor has three main sections: a wood holding section 20, a heating section 30, a heat recovery section 40 and a container 50. The container 50 houses the three sections 20, 30, 40. A receptacle 60 may be provided beneath the container 50 to receive liquid byproducts that are formed during the carbonization process.

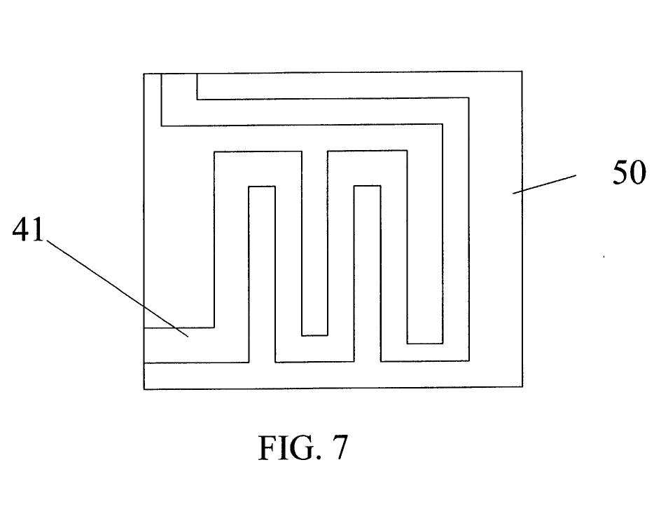

The heat recovery section 40 includes a steam valve 1, a water hose 2, a water reservoir 3, a water level control 4, a steam temperature control 6, and water 10. The water reservoir 3 may be piping 41 arranged in a serpentine fashion around each end and side and the top of the container 50 as may be envisioned from FIG. 7. The heat section 30 includes resistors heat control 7 and a line of resistors 8 and a body 9. The wood holding section 20 includes a fire grate enclosure 5. The container 50 includes a body 9, an incline 11, stopcock faucet 12 that includes a double valve, legs 13, separators 14 and a door 15. When the door 15 is closed, the container is hermetically sealed in accordance with any conventional technique for hermetically sealing a metal container.

Waste wood and other products that are to be transformed, such as into wood charcoal, are inserted within confines of the fire grate enclosure 5 while the door 15 to the container 50 is open. Once the fire grate enclosure 5 is fully loaded, the door 15 is closed to hermetically seal the container 50. The fire grate enclosure 5 may be made of spaced apart steel bars and includes a base, two side walls and, possibly, one or two end walls. The fire grate enclosure 5 may be open or closed at the top. If completely enclosed, the fire grate enclosure 5 needs to have at least the top or an end wall that is hinged or otherwise opened to enable the insertion and removal of the wood contents of the fire grate enclosure 5. To facilitate easy transfer of the fire grate enclosure with a fork lift vehicle whether the container 50 is large, the fire grate enclosure 5 need not be a single unit but rather multiple units each being individually movable with the fork lift.

The walls of the body 9 of the container 50 may be made of metal sheet. To facilitate easy insertion and removal of the fire grate enclosure 5 from the container 50, either the underside of the fire grate 5 is equipped with spaced apart legs 13 that may be metallic or the spaced apart legs 13 may rise from the floor of the container 50. The spacing between the legs enables a forklift truck or other similar vehicle to insert its fork on either sides of the legs to raise the fire grate enclosure 5 for insertion into and removal from the container 50 when the door 15 is open.

The container 50 has a discharge port 12 that may be a conventional stopcock faucet that includes a double valve that opens or closes. Provision is made in a conventional manner to automatically close the discharge port 12 in response to removal of the receptacle 60. For instance, the discharge port 12 may open in response to connection with a connecting port of the receptacle and close in response to its removal, provided the sensed temperature inside the container 50 is within certain limits. The stopcock faucet and double valve may be considered an isolation element in that the outside is sealed off when the stopcock faucet and double valve is closed and in communication with the receptacle 60 (which itself is hermetically sealed) when the stopcock faucet and double valve is open.

The incline 11 of the container slopes downwardly to the discharge port 12. Once all the liquid products that are formed during the carbonization process and other wood charcoal forming processes have finished flowing into the receptacle 60, the receptacle 60 may be removed, which removes the operator that triggers hermetically closing the discharge port 12.

The heat section 30 includes heating elements, which may be the line of resistors 8 whose heating is controlled by the resistors heat control 7. The resistors heat control 7 controls the amount of heat generated by the line of resistors 8 to keep the interior of the container at an appropriate temperature during each stage of the wood charcoal transformation process. The resistance elements may be electric resistors that generate heat from electricity. The electricity may be generated from electric generators 60 that are fueled by wood charcoal and/or may be generated from solar energy panels 70.

Excess heat generated from the line of resistors 8 may be used to transform water 10 in a surrounding water reservoir 3 into steam under control of steam temperature control 6. The steam may be discharged through a steam discharge valve 1 to be used by other pieces of equipment and the vapor lost replaced by fresh inflow of water under control of the water level control 4.

After the wood waste in the fire grate enclosure 5 is transformed into wood charcoal, the wood charcoal is allowed to cool. While the container 50 is still hot, an identical fire grate enclosure that contains a fresh supply of waste wood may be inserted into the container 50. The container door 15 is again closed to hermetically seal the container 50. The same or an identical receptacle 60 may be attached to the discharge port 12 to receive and hold liquid products formed during the carbonization process, such as tar. The fresh supply of wood waste is transformed into wood charcoal. The removal and insertion of each fire grate enclosure 5 is done with a conventional forklift vehicle.

The incline 11 may be separate from the fire grate enclosure 5 so that at least a portion extends between the fire grate enclosure 5 and the floor of the container 50. Alternatively, the incline 11 may be part of the fire grate enclosure 5. As a further alternative, the floor of the container may be sloped and serve as the incline 11.

The legs 13 may be replaced by any type of support that elevates the fire grate enclosure 5 off the floor of the container 50. Such a support could extend from ceiling of the container or extend from side walls of the container. The fire grate enclosure 5 itself could be constructed to accommodate the insertion of a fork of a forklift so that the fire grate enclosure 5 could rest on the floor of the container. 50. For instance, the fire grate enclosure 5 could be equipped with sleeves (not shown) that accommodate insertion of the fork.

The door 15 is preferably at an end face of the reactor, but may be at any face. The door may or may not be hinged by hinges 21. Flush with or recessed inwardly of the open end is a frame 16 that is lined with insulation. To close the door 15, the door 15 is placed against the frame 16.

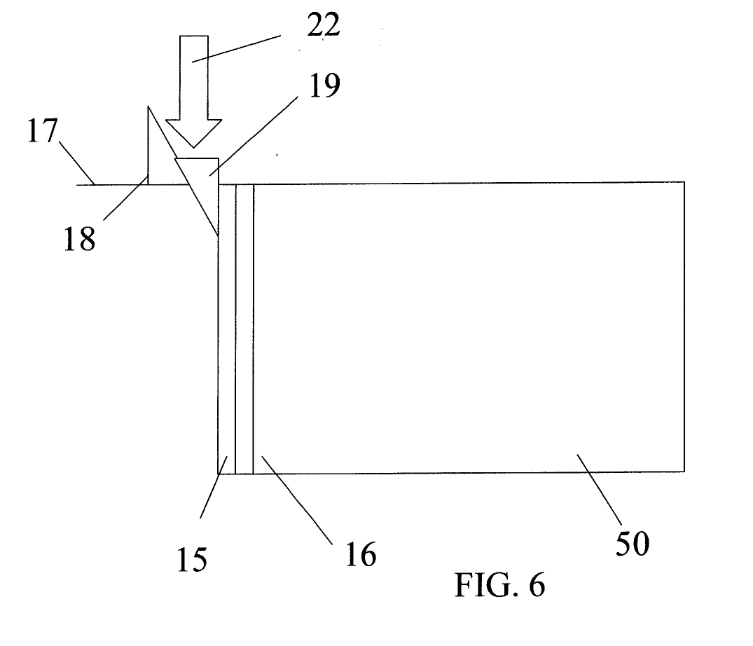

An overhang 17 protrudes from the top of the reactor and forwardly above and past the open end of the reactor. The overhang 17 holds a door sealing mechanism that includes a guide 18 and a clamp 19 that slides along the guide 18 between a retracted position and an extended position. In reaching the extended position, the clamp 19 passes through a slot in the overhang 17. As seen in FIG. 6, a force 22 is applied to the clamp 19 and maintained throughout the entire reactor heating and cooling procedures.

The clamp 19 is spring biased to press against the outside of the door 15. In view of the insulation that lines the frame 16, the open end of the reactor hermetically seals because of the door 15 pressing against the frame 16. The force 22 may be a spring biased force applied by a spring (not shown).

Further, when operated, the contents of the fire grate enclosure 5 when heated create a vacuum that further exerts a sucking pressure against the door 15 that promotes further sealing of the door 15 against the frame 16. In response to any inward movement of the door 15, the clamp 19 further presses against the door 15 from the outside because of the door sealing mechanism.

To open the door after the wood charcoal is fully cooled, the door sealing mechanism is released so that the clamp 19 is moved from the extended position into the retracted position and the door 15 is then opened. Such a movement of the clamp 19 may arise upon removal or the spring bias force. Such removal may arise by exerting a force of sufficient magnitude against the spring bias force to cause the clamp 19 to slide along the guide 18 and thus prevent the spring bias force from acting on the door 15. If the door 15 is hinged, the hinge may include a spring bias mechanism itself to open the door 15 after the clamp 19 is removed. Handles may be provided on the door to aid in the effort at pulling open the door 15. If there still remains some vacuum inside the container 50 that prevents easy moving of the door 15, then more powerful conventional pulling devices (such as with pulleys) may be employed to assist in opening the door by having such device grasp the door handles. The discharge port 12 may be opened to relieve vacuum pressure that may still remain.

Although the present invention is exemplified for use in transforming waste wood into wood charcoal, the reactor may be used with any form of material that, when subjected to a carbonization process, will transform into wood charcoal, acids, finished products, or purified by the removal of moisture and impurities. The initial stages of transforming vegetable or organic matter into biofuels or biodiesel may include heating to remove moisture, which may be carried out with the present portable reactor by heating at appropriate temperatures for such a transformation process.

The incline 11 may be dispensed with if the discharge port 12 is instead a large opening in the floor of the container beneath the fire grate enclosure 5. The receptacle 60 may be located beneath this large opening to receive any liquid tar or other liquid residue formed during the carbonization process. When all the liquid tar and liquid residue is formed and before the temperature inside the reactor is raised to a higher temperature that would solidify the liquid tar and liquid residue, an isolation element is moved to seal off the large opening. The receptacle 60 and its contents are removed. The isolation element in this case may be a slidable, insulated panel that is to be clamped against an insulated frame to close the large opening in the same manner under spring bias that the door 15 clamps against the frame 16 to close.

If the incline 11 is used, the incline 11 is preferable removable in and out of the container to enable cleaning of tar and other residue on its surface and to allow a clean replacement incline to be inserted instead for continued operation. The incline 11 would be removed after the door 15 has been opened and the fire grate enclosure 5 removed after cooling is complete. The legs 13 may be attached to the incline and removable with it for cleaning so that the replacement incline may include replacement legs as well. To avoid damage to the stop faucet and double valve if such is used, the stop faucet and double valve is not removable with the incline but is rather is attached to the container and may be air or steam cleaned in place. The resistors may be air cleaned at this time to remove any residual dust on their surfaces.

While the foregoing description and drawings represent the preferred embodiments of the present invention, it will be understood that various changes and modifications may be made without departing from the spirit and scope of the invention.

What is claimed is:

1. A reactor, comprising:
at least one enclosure configured to hold material to be transformed under heat;
at least one heating element configured to supply the heat;
a container that houses the at least one enclosure and the at least one heating element, the container including an open end, a frame that bounds the open end, and a door that is configured to hermetically seal the open end in response to forces exerted on the door that press the door against the frame, the open end being of a dimension to accommodate passage of the enclosure in tact through the open end;
a discharge port configured to open and close; and
an incline that slopes to the discharge port beneath the enclosure.

2. A reactor as in claim 1, further comprising a heat recovery section surrounding at least a portion of the container, the heat recovery section including a reservoir of water.

3. A reactor as in claim 1, further comprising sensors and a heating control configured to control a temperature within the container for periods of time and at levels consistent with that required for transforming wood into wood charcoal.

4. A reactor as in claim 1, wherein the incline is part of the enclosure.

5. A reactor as in claim 1, wherein the incline is separate from the enclosure.

6. A reactor as in claim 1, wherein the enclosure includes spaced apart bars.

7. A reactor as in claim 1, further comprising supports that elevate the enclosure, the supports being spaced apart from each other.

8. A reactor as in claim 1, wherein the enclosure is configured to accommodate insertion of a fork of a forklift.

9. A reactor as in claim 1, further comprising a receptacle located outside of the container and in communication with an interior of the container via the discharge port.

10. A method of assembling a reactor, comprising the steps of:
opening a door of a container from a closed condition to an open condition;
placing material to be transformed by heating into at least one enclosure;
passing the at least one enclosure through an open end of the container and inserting the at least one enclosure within the container;
sloping an incline to a discharge port in a floor of the container;
applying a force on the door to press the door against a frame to hermetically seal the container and close an open end of the container with the door, the frame bounding the open end of the container; and
heating the material with at least one heating element within the container.

11. A method as in claim 10, further comprising elevating the enclosure.

12. A method as in claim 10, further comprising using a forklift to move the enclosure in tact with the door of the container in the open condition.

13. A method as in claim 10, further comprising arranging a receptacle outside the container that is in communication with an interior of the container via the discharge port.

14. A method as in claim 10, further comprising recovering heat emerging from the container from the heating by using a water reservoir that at least partially surrounds the container.

15. A method as in claim 10, further comprising maintaining a temperature within the container for periods of time and at sufficient levels that are consistent with forming wood charcoal from wood waste in the enclosure.

16. A method as in claim 10, further comprising filling the enclosure with wood waste as the material before inserting the enclosure, subsequently opening the door after the wood waste is transformed into wood charcoal and removing the enclosure in tact from the container.

17. A method as in claim 10, further comprising transporting the container and the enclosure to a location where there are waste materials, filling enclosure with the waste materials prior to the inserting.

18. A reactor, comprising:
at least one enclosure configured to hold material to be transformed under heat;
at least one heating element configured to supply the heat;
a container that houses the at least one enclosure and the at least one heating element, the container including an open end and a discharge port, a frame that bounds the open end, and a door that is configured to hermetically seal the open end in response to forces exerted on the door that press the door against the frame, the open end being of a dimension to accommodate passage of the enclosure in tact through the open end; and
an isolation element movable between an open and closed position so that the discharge port is open when the isolation element is in the open position and the discharge port is closed in a hermetically sealed manner when the isolation element is in the closed position, the isolation element being situated beneath the at least one enclosure when the discharge port is closed by the isolation element.
